(19) United States
(12) Patent Application Publication
(10) Pub. No.: US 2023/0067110 A1
(43) Pub. Date: Mar. 2, 2023

(54) MOBILE SAFETY DEVICE

(71) Applicant: Vetter GmbH, Zülpich (DE)

(72) Inventor: Carsten SAUERBIER, Lauf an der Pegnitz (DE)

(21) Appl. No.: 17/792,936

(22) PCT Filed: Jan. 15, 2020
(86) PCT No.: PCT/EP2020/050882

§ 371 Date: Jul. 14, 2022

(51) Int. Cl. A62B 1/22; B64C 39/02

(52) U.S. Cl. CPC A62B 1/22; B64C 39/024; B64C 2201/143

(57) ABSTRACT

A mobile safety device (1) is for rescuing at least one person at risk of falling. The safety device includes a support device (2) in the form of a jumping cushion, jumping sheet, platform, base plate or stretcher for receiving and transporting the person at risk of falling. A positioning device (3) locally positions the support device (2) at the location of the person at risk of falling. At least one unmanned, remote-controlled drone (4a, 4b, 4c, 4d) is provided as the positioning device (3).

The present application relates to a mobile safety device for rescuing persons at risk of falling according to the preamble of claim 1.

### TECHNOLOGICAL BACKGROUND

Jumping cushions are used in the rescue sector for rescuing persons who are at risk of falling. In particular if the use of a turntable ladder vehicle is not possible because the rescue height of the person exceeds the maximum rescue height of the turntable ladder vehicle or the vehicle is not able to drive up to the rescue site, the use of jumping cushions is appropriate. Jumping cushions are inflated with the aid of compressed air bottles or compressors until an overpressure of, for example, approximately 0.3 is set. If a jumping cushion is set up and a person jumps onto the jumping cushion, as the person plunges thereinto, this person is gently slowed down by means of a rapid pressure equalization of the jumping cushion with the environment. The rescue height of persons to be rescued is a limiting factor for jumping cushions since with increasing drop height, they absorb more kinetic energy and thus have to be dimensioned larger. Jumping cushions are currently permitted up to a maximum rescue height of 60 m.

With increasing rescue height, the jumping cushion seems very small from the perspective of the person to be rescued, which greatly increases the risk of the person to be rescued hitting the jumping cushion incorrectly or not at all when said person jumps. This can have fatal consequences since the person to be rescued can be seriously injured or, as a result of the impact, fatally injured. The person to be rescued may also bounce off the jumping cushion, which represents a considerable safety risk for the rescue personnel. It is therefore of particular importance for the jumping cushions to be correctly positioned. However, this becomes difficult with increasing rescue height. In addition, due to the great weight of the jumping cushion, the position of the jumping cushion in its inflated state can only be changed with difficulty, which prevents a fast response. In addition, several persons are required for installing and removing rescue cushions.

### DOCUMENTED PRIOR ART

CN 205814896 discloses an automatic unmanned and mobile safety device for rescuing persons at risk of falling. The safety device consists of a jumping cushion which is mounted on a positioning device. The movements of the safety device are realized with the aid of specially designed wheels, which enable an omnidirectional freedom of movement on the ground. In addition, the safety device is equipped with a Doppler radar unit to determine the trajectory of a falling person. The data determined are used for the precise and rapid positioning of the safety device in order to maneuver it into the trajectory of the person to be rescued and to catch said person safely with the jumping cushion.

A further safety device is known from CN 107346141, in which a jumping cushion is mounted on an automatic unmanned and mobile chassis. With the aid of a binocular system, this mobile safety device can recognize the trajectory of the person to be rescued and move into the trajectory by means of specially designed wheels. At the same time, a blower is activated in order to inflate the jumping cushion. The person to be rescued can thus be safely caught by the safety device.

In both publications, the mobile safety device can only be moved on the ground, which severely restricts the usability of the system. In addition, it is not possible to use this mobile safety device on rough terrain, for example in the case of wooded or fissured areas.

### OBJECT OF THE PRESENT INVENTION

The object of the present invention is to provide a safety device which enables the rescue of persons at risk of falling from a great rescue height.

### ACHIEVEMENT OF THE OBJECT

The above object is achieved by the features of claim 1. Expedient embodiments are claimed in the dependent claims.

According to the invention, at least one drone is provided as a positioning device of a mobile safety device. Said drone is connected to a support device for receiving the person who is at risk of falling. Preferably, the support device is surrounded by a railing which is preferably open on one side. The support device can thus be designed in particular in the manner of a basket that is open laterally on one side or a container that is open on the upper side. This results in the advantage that the mobile safety device is easily accessible for the person to be rescued. In particular, there is also the possibility that the person to be rescued is able to jump from a certain distance and/or height onto the safety device if circumstances do not permit the mobile safety device to be maneuvered into the immediate proximity of the rescue person. It is possible to position the safety device freely in three-dimensional space. The safety device thus also allows the rescue of persons at risk of falling from a greater height, in particular from a height outside the permissible jump height of jumping cushions. The safety device can be controlled from a base station which can, if necessary, also be operated by just one person. As a result, fewer personnel are required than in the case of previously available jumping cushions. This enables rescue personnel to carry out other tasks during the rescue operation. Furthermore, the safety device can also be used in particularly rough terrain.

Expediently, multiple drones can be used to position the safety device. As a result, it is also possible in particular to achieve very good flight stability and/or reactivity in the case of air turbulence, in particular under difficult conditions, for example in the case of increased asymmetrical air currents which develop due to local thermals (e.g., in the case of a building fire) and/or in the case of one-sided loading (e.g., by jumping onto one side) and/or in the case of uneven load distribution. Preferably, at least four, particularly preferably at least six, drones can be provided in this case.

Preferably, the drones can be connected to the edge region and/or the corner region of the support device.

It can be particularly useful if the at least one or the plurality of drone(s) is/are located above the support device.

According to an alternative development of the present invention, the at least one or the plurality of drone(s) is/are located below the support device.

Advantageously, the drones can be synchronized with one another in their flight position and flight movement in order to ensure an even trajectory and a fast response of the safety device. This enables a particularly precise control and simplifies the positioning of the safety device.

According to one useful development of the present invention, the safety device is equipped with a camera system comprising at least one camera. This allows images to be transmitted regarding the operation. Furthermore, the operator of the base station can, if necessary, also control the safety device without direct visual contact. Another advantage of this development is that even in the case of a great rescue height, the safety device can be precisely controlled and positioned via the camera system. The risk of incorrect positioning and of serious accidents resulting from this can thus be minimized.

Preferably, data can be transmitted in real time from the camera system to a receiver, preferably a base station.

The safety device is preferably equipped with a sensor system for environment detection, wherein the sensor system comprises at least one, preferably a plurality of sensors.

By the sensor system being equipped with distance sensors, a desired distance to objects in the immediate vicinity of the safety device, for example to trees and/or buildings, can preferably be maintained automatically by the safety device. This significantly simplifies the handling of the safety device. In addition, the safety device can be positioned, preferably automatically, precisely, for example at a certain distance from a window, so that via this distance or gap a person to be rescued reaches the safety device easily and without being inhibited by the rescue location.

A movement detection system, which automatically detects the path of the jump or falling trajectory of the person to be rescued and continuously corrects or adjusts the position of the safety device, is particularly expedient as a sensor system. A LIDAR, radar and/or ultrasound system is suitable as a movement detection system, for example. As a result, the position of the safety device can be automatically adapted to the determined jump path or falling trajectory of the person to be rescued, as a result of which it can be ensured that the person to be rescued is safely caught by the latter and serious accidents can be avoided when jumping onto the safety device.

Furthermore, the sensor system can have at least one sensor for determining the flight altitude and/or the position (e.g., for determining the operational height and/or the distance) of the person to be rescued.

The fact that the safety device can be equipped with a sensor system for inclination detection has the advantage that the safety device can always be aligned horizontally and a tilting, for example due to a one-sided load or by the influence of thermal currents, can be compensated by a targeted actuation of individual or multiple drones.

In a further development of the invention, the connection of the positioning device between the drones and the support device is rigid, as a result of which the movement of the drones is transmitted directly to the support device. Preferably, rigid connecting elements made of plastic, fiber composite or metal, in particular light metal, are used.

According to an alternative development of the present invention, the connection of the positioning device between the drones and the support device is flexible in order to allow the drones a somewhat freer positioning or movement in relation to the support device. A flexible connection can be, for example, a cable or a chain.

Since the support device of the safety device is at least partially permeable to air currents, this supports the aerodynamic lift and thus the efficiency of the drone. In addition, thermal currents possibly occurring due to heat development caused by a building fire affect the positional stability of the support device less.

Due to the fact that a conventional jumping cushion is located on the support device, it is even possible to rescue persons in situations in which it is not possible to position the safety device directly by the person. However, the safety device according to the invention can be positioned at a still sufficient “intermediate height” below the position of the person to be rescued. In contrast to previously available jumping cushions, the jump height for the person to be rescued can therefore be significantly reduced. This also reduces the risk of the person to be rescued being injured in a rescue jump. In addition, with a reduced jump height the jumping inhibition of the person to be rescued is also weaker.

Preferably, plastics (preferably PVC), fiber composites or metals, in particular light metals, are used as sheeting and frame material.

According to a further embodiment, the support device can be designed to be rigid. As a result, the person to be rescued can “climb” particularly easily onto the support device.

If necessary, the support device can also be designed as a stretcher.

It is particularly advantageous if the safety device can be controlled by means of a computer, preferably by means of a tablet computer, in particular from the ground. Control is preferably effected via a downloadable app that is downloaded onto the computer. Control data can be stored centrally, for example in a computer cloud. The centrally stored data can also be linked to location and/or environmental data and/or weather data from other databases. In this way, additional data can be included in controlling the safety device.

The safety device preferably does not have a closed housing or chassis, so that the support device is unhindered and freely accessible.

### DESCRIPTION OF THE INVENTION ON THE BASIS OF EXEMPLARY EMBODIMENTS

Advantageous developments of the present invention are described in more detail below. For the sake of clarity, recurring features are only provided with a reference sign once. In the drawings:

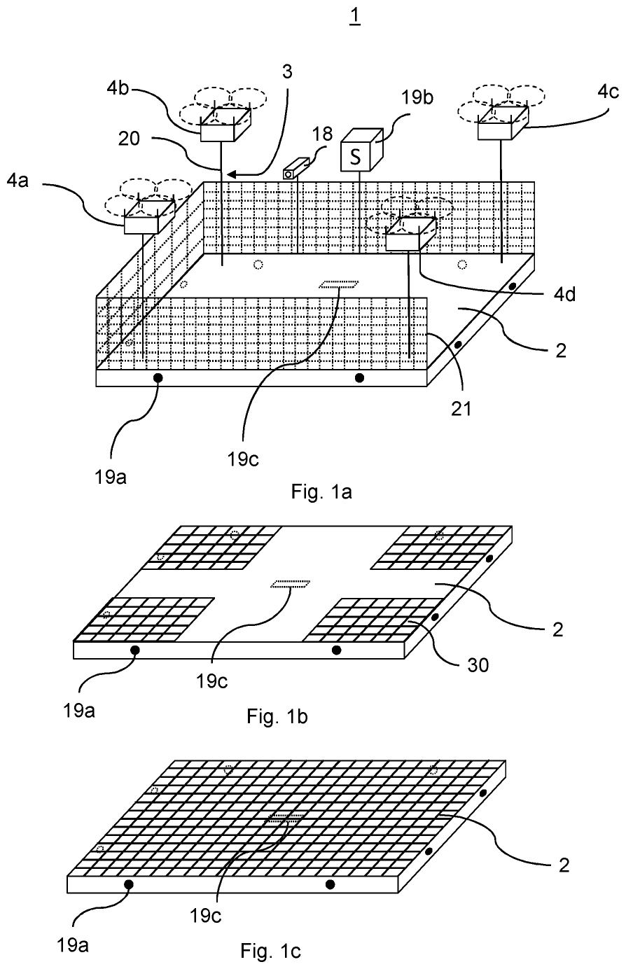

FIG. 1a shows a schematic perspective view of a first embodiment of a safety device according to the present invention;

FIG. 1b shows a schematic perspective view of an alternative support device;

FIG. 1c shows a schematic perspective view of a further alternative support device;

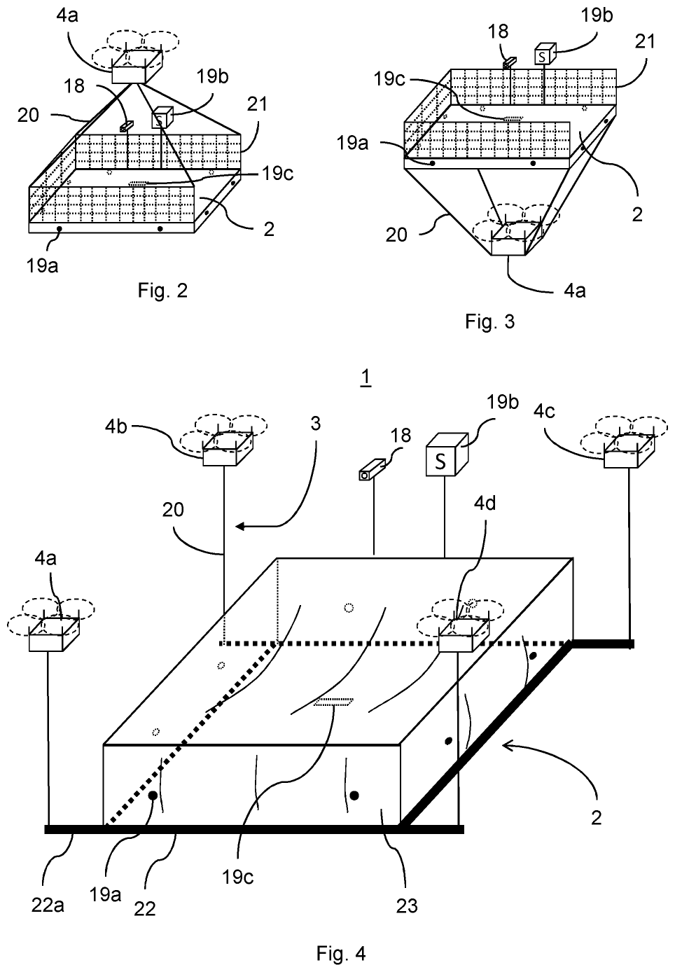

FIG. 2 shows a schematic perspective view of a second embodiment of a safety device according to the present invention;

FIG. 3 shows a schematic perspective view of a third embodiment of a safety device according to the present invention;

FIG. 4 shows a schematic perspective view of a fourth embodiment of a safety device according to the present invention;

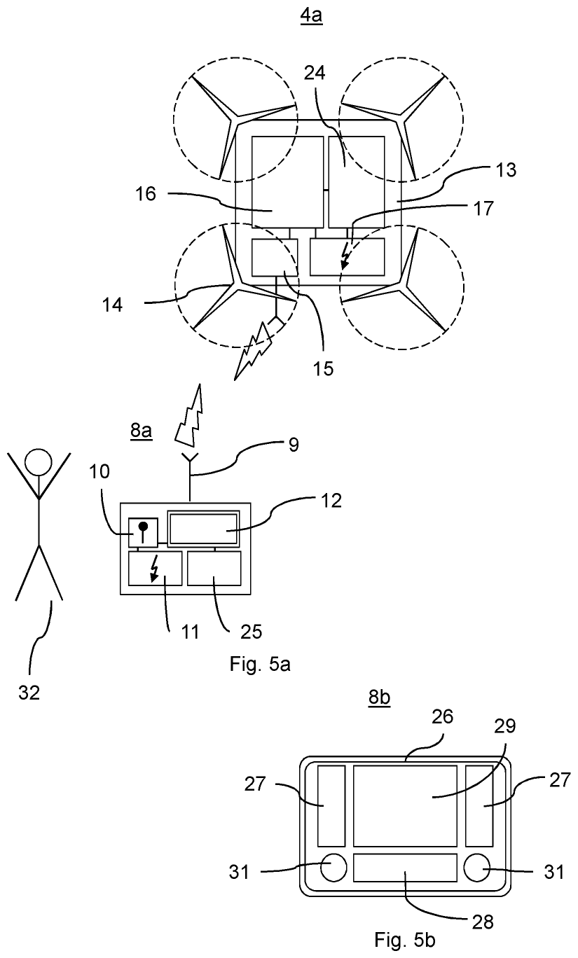

FIG. 5a shows an exemplary representation of the functional elements of a drone of the safety device, and of the functional elements of a base station for controlling the safety device;

FIG. 5b shows a schematic representation of a base station in the form of a tablet computer, and

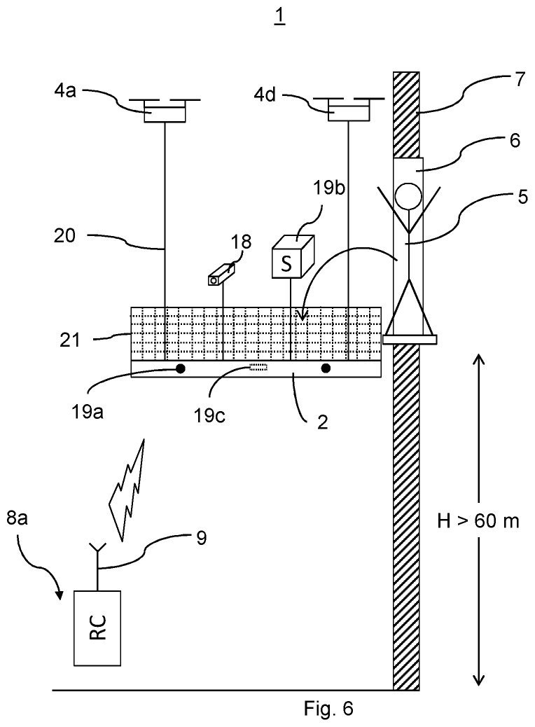

FIG. 6 shows a schematic representation of the use of a safety device according to the invention using the example of the safety device according to FIG. 1a.

Reference sign 1 in FIG. 1a refers to an embodiment of a mobile safety device according to the invention in its entirety. The mobile safety device 1 comprises a flat, e.g., square, support device 2 in the form of a base plate. Instead of a rectangular shape, the support device 2 can also have a different geometric shape, for example a round, oval, or polygonal shape.

The support device 2 is supported by, for example, four positioning devices 3, each positioning device 3 comprising an unmanned drone 4a-d and an associated connecting element 20. The connecting element 20 connects the respective drone 4a-d with the support device 2, preferably at its edge region and/or corner region.

In the version shown in FIG. 1, the drones 4a-d are located above the support device 2. The drones 4a-d are designed in such a way that in flight, the safety device 1 is able to transport at least one person. The drones 4a-d are advantageously synchronized with each other in their movement. As a safety device, the safety device 1 may include a circumferential railing 21. The railing 21 may be completely or at least partially missing on one side of the safety device 1 in order to allow access to the support device 2. The railing 21 extends upward at a certain height from the support device 2, comparable to a window or door parapet in a building. The railing 21 may, for example, be formed as a lattice structure.

The safety device 1 can comprise a camera system. The camera system comprises at least one camera 18, which transmits the data, preferably in real time, to a base station 8a, cf. FIG. 6. The camera system makes it possible to map the immediate operating environment of rescue facility 1 in the area of base station 8a, preferably in real time.

Furthermore, the safety device 1 may comprise a sensor system, which serves to enable a positioning of the safety device 1. The sensor system shown in FIG. 1a comprises various sensors.

These sensors are, for example, distance sensors 19a, which enable a measurement of the distance of the safety device 1 from the environment, such as a house wall; see FIG. 6. As a result, for example, a minimum distance to be automatically maintained can be set. The generated distance data can, for example, be sent to the base station 8a in order to support the controller.

Furthermore, the sensor system may include a motion detection system with at least one motion sensor 19b. The motion detection system is particularly suitable for aligning the position of the safety device 1 when a person to be rescued, cf. FIG. 6, tries to jump onto the safety device. As a result, the person 5 to be rescued can be caught safely.

Furthermore, the sensor system may include an inclination detection system with at least one inclination sensor 19c in order to determine the inclination of the support device 2. As a result, it can be ensured that the support device 2 is aligned in its horizontal position, in particular with a one-sided load. The sensors of the aforementioned sensor system may be located on and/or in the support device 2 and/or on a drone(s) 4a-d.

Furthermore, the sensor system can have at least one sensor for determining the flight altitude and/or the position (e.g., for determining the operational height and/or the distance) of the person to be rescued.

An alternative embodiment of the support device 2 is shown in FIG. 1b. In this case, the support device 2 is partially permeable to air currents. In this version, air current ducts 30 are provided at the corners of the support device 2. The air currents generated by the drones 4a-d can thus flow through these. As a result, the drones 4a-d have better aerodynamic properties, which allows them to work more efficiently. The air current ducts 30 can be, for example, grids or nets. The connecting elements 20 can preferably be connected to the support device 2 by the grille, or for example alternatively by struts or rods (not shown in FIG. 1b), so that the drones 4a-d are positioned above the air current ducts 30.

A further alternative embodiment of the support device 2 is shown in FIG. 1c. Here, the support device 2 is completely permeable to air currents. With a support device 2 completely permeable to air currents, the air currents generated by the drones 4a-d can flow even more efficiently through the support device 2. In particular, with a support device 2 completely permeable to air currents, the drones 4a-d can be positioned more freely in relation to the support device 2.

FIG. 2 shows an alternative embodiment of the safety device 1. Here, a single drone 4a is used, which is located above the support device 2. In all other respects, the safety device 1 corresponds to the other embodiments. The drone 4a is connected to the support device 2 via several connecting elements 20. For example, from each corner of the railing 21 of the support device 2, a connecting element 20 can run to the drone 4a. In this case, the connecting elements 20 can be not only rigid but also flexible.

The alternative version of the mobile safety device 1 shown in FIG. 3 shows a single drone 4a, which is located below the support device 2. In all other respects, the safety device 1 corresponds to the other embodiments. In this embodiment, however, the connecting elements 20 are rigid and connect the drone 4a to the support device 2, preferably via the four corners thereof.

FIG. 4 shows an alternative version of the safety device 1. On the support device 2, there is a jumping cushion 23. This embodiment can be used, in particular, when it is not possible to position the safety device directly by the person to be rescued, so consequently the person to be rescued must jump onto the jumping cushion 23. This can be the case, for example, if the person 5 to be rescued is, for example, below a balcony protrusion and the safety device 1 can therefore not reach as far as the person 5. The support device 2 comprises an outer frame 22, preferably a tubular frame, to which the jumping cushion 23 is attached. In order to prevent the drones 4a-d from being struck by a jumping person, they are, for example, offset further outward by an additional frame element 22a as compared to the surface of the support device 2. The connecting elements 20 connect the drones 4a-d to the frame element 22a. In all other respects, the safety device 1 corresponds to the other embodiments.

The safety device 1 according to the invention is controlled from the ground by an operator 32 by means of a base station 8a, which is connected to the at least one drone 4a-d via a wireless data connection (radio connection).

FIG. 5a shows an exemplary design of the functional elements of the base station 8a and an exemplary drone 4a in each case for controlling the safety device 1 according to the invention by the operator 32. The base station 8a comprises a control element 10, a control display 12, a control unit 25, as well as a transceiver 9 with antenna for bidirectional data transmission, preferably in real time. The functional elements of the base station 8a are supplied with electrical energy by an energy source 11 (for example, battery or rechargeable battery). The control unit 25 comprises a processor that performs the control and computing functions of the base station 8a. The control display 12 displays, for example graphically, the various camera and/or sensor data and/or status data of the safety device 1 and/or of the base station 8a. The base station 8a allows simple control of the safety device 1 with the aid of the control element 10. This can preferably take the form of a joystick. The control commands are transmitted via the transceiver 9 of the base station 8a to a transceiver 15 with antenna of the drones 4a.

The functional elements of the drone 4a are housed in a housing 13 of the drone and advantageously protected against external influences, such as moisture and/or dust. The functional elements of the drone 4a include a power supply 17 (e.g., battery or rechargeable battery), a control unit 16, a data interface 24 and a transceiver 15 with antenna. The transceiver 15 is suitable for bidirectional data transmission between the drone 4a and the base station 8a as well as for bidirectional data transmission between the drone 4a and other drones of the safety device 1. The data interface 24 regulates the inclusion of data from the various sensor and/or camera systems which the safety device 1 may include. The control unit 16 of the drone 4a controls the rotors 14 of the drone 4a. By targeted control of the lift of the individual rotors 14 of the drone 4a, the movement of the respective drone can be controlled. This enables a purposeful movement of the safety device 1 in three-dimensional space. Preferably, the control unit 16 receives the control commands for the drone from the base station 8a and, if necessary, additionally from sensors via the data interface 24.

During the control of the safety device 1, sensor data are preferably captured and transmitted in real time. Due to the bidirectional data transmission between the drones 4a-d and the base station 8a, control can be executed immediately. Thus, it may be possible, for example, to enable an automatic flight adjustment of the safety device 1, if, for example, the inclination detection system detects, via a setpoint, an inclination of the safety device 1 setting in, or to automatically steer the safety device 1 into the trajectory of the person 5 to be rescued.

The drones 4a-d are preferably controlled via an app. Live images of the camera systems and/or real-time data of the various sensor systems and/or status data, such as the charging voltage and the currently required power of the safety device 1, can be displayed in individual or different windows.

Control is preferably effected via a downloadable app that is downloaded onto the computer. Control data can be stored centrally, for example in a computer cloud. The centrally stored data can also be linked to location and/or environmental data and/or weather data from other databases. In this way, additional data can be included in the control of the safety device.

In an alternative embodiment, the control device of the drones 4a-4d is provided centrally at the safety device 1.

The drones 4a-d may accordingly be drones 4a-d that only include propulsion systems, whereby all propulsion systems are supplied by one (not shown in the figure) common control unit and/or energy source.

According to a special embodiment of the base station 8a, the base station 8a represents a computer 8b, preferably a tablet computer, as shown in FIG. 5b. The tablet computer comprises a conventional multifunction display 26, in which at least one finger-operated, touch-sensitive control element 31 generates a window 29 for displaying the live images of the camera systems, a window 27 for displaying the real-time data of the various sensor systems and a status display 28 of the drones 4a-4d. If necessary, the tablet computer may also be coupled with a control element 10 of the described type for controlling the safety device.

An application case of a safety device 1 according to the invention is presented in FIG. 6 using the example of the safety device 1 according to FIG. 1a. This can be, for example, a case of a building fire in which a person 5 to be rescued can only be rescued via a window 6. The safety device 1 can be positioned very close to the window 6 at the height thereof, so that the gap between the window 6 and the support device 2 is small. The distance sensor 19 prevents the safety device 1 from colliding with the house wall 7. This has the advantage that the person 5 to be rescued can enter the safety device 1 directly and fearful states of the person 5 to be rescued can be reduced. The inclination sensor 19c ensures a horizontal alignment of the support device 2 while the person is on it. Insofar as the support device 2 is at least partially permeable to air currents, thermals which occur in the event of a fire can flow through the support device.

It is expressly pointed out that the combination of individual features as well as secondary features should be regarded as essential to the invention and encompassed by the disclosure content of the application.

### LIST OF REFERENCE SIGNS

1 Safety device
2 Support device
3 Positioning device
4a Drone
4b Drone
4c Drone
4d Drone
5 Person to be rescued
6 Window
7 House wall
8a Base station
8b Computer
9 Antenna
10 Control element
11 Power supply
12 Control display
13 Base body
14 Rotor
15 Antenna
16 Control unit
17 Power supply
18 Camera system
19a Distance sensor
19b Motion sensor
19c Inclination sensor
20 Connecting element
21 Railing
22 Frame
22a Frame element
23 Jumping cushion
24 Data interface
25 Control unit
26 Display
27 Sensor data
28 Status data
29 Live image
30 Air current ducts
31 Touch-sensitive control element
32 Operator

1. Mobile safety device for rescuing at least one person at risk of falling, comprising
a support device in the form of a jumping cushion, jumping sheet, platform, base plate or stretcher for receiving and transporting the person at risk of falling,
a positioning device for locally positioning the support device at the location of the person at risk of falling,
wherein
the positioning device comprises at least one unmanned, remote-controlled drone.

2. Safety device according to claim 1, comprising a plurality of the drones.

3. Safety device according to claim 1, wherein each of the at least one drone is connected to an edge region and/or a corner region of the support device.

4. Safety device according to claim 1, wherein the at least one drone is located above the support device.

5. Safety device according to claim 1, wherein the at least one drone is located below the support device.

6. Safety device according to claim 1, wherein the at least one drone comprises a plurality of drones synchronized with one another in flight positions and/or flight movements.

7. Safety device according to claim 1, wherein the safety device comprises a camera system having at least one camera.

8. Safety device according to claim 7, wherein data of the camera system are transmitted, in real time, to a receiver.

9. Safety device according to claim 1, wherein the safety device comprises at least one sensor system for environment detection, having at least one sensor.

10. Safety device according to claim 9, wherein the sensor system of the safety device is at least one distance sensor.

11. Safety device according to claim 9, wherein the sensor system is at least one motion sensor for the person to be rescued.

12. Safety device according to claim 11, wherein a position of the safety device is matched to a determined jump path or fall trajectory of the person to be rescued.

13. Safety device according to claim 9, wherein the sensor system comprises at least one inclination sensor of the support device.

14. Safety device according to claim 1, wherein connection of the positioning device between the support device and at least one unmanned remotely controlled drone is rigid.

15. Safety device according to claim 1, wherein connection of the positioning device between the support device and at least one unmanned remotely controlled drone is flexible.

16. Safety device according to claim 1, wherein the support device is at least partially permeable to air currents.

17. Safety device according to claim 1, wherein a jumping cushion is located on the support device.

18. Safety device according to claim 1, wherein the support device (2) is rigid.

19. Safety device according to claim 1, wherein the safety device is controllable by a computer.
